(19) United States
(12) Patent Application Publication
(10) Pub. No.: US 2007/0276062 A1
(43) Pub. Date: Nov. 29, 2007

(54) Process For Producing An Epoxidized Elastomeric Polymer

(76) Inventors: Diego Tirelli, Milano (IT); Michela Caprio, Milano (IT); Luigia Rossiello, Milano (IT); Lisa Grassi, Milano (IT); Emillano Resmini, Milano (IT); Stefano Testi, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/584,400

(22) PCT Filed: Dec. 24, 2003
(86) PCT No.: PCT/EP03/14911

§ 371 Date: May 14, 2007

(51) Int. Cl. C08C 19/06; C08F 8/08

(52) U.S. Cl. 523/400; 525/344; 525/360; 525/368; 525/387

(57) ABSTRACT

A process for producing an epoxidized elastomeric polymer by feeding at least one elastomeric polymer containing ethylenic unsaturation to a mixing device; feeding at least one hydrogen peroxide precursor to the mixing device; feeding at least one carboxylic acid or a derivative thereof to the mixing device; mixing and reacting, in the presence of water, the at least one elastomeric polymer containing ethylenic unsaturation with the at least one hydrogen peroxide precursor and the at least one carboxylic acid or a derivative thereof, to obtain an epoxidized elastomeric polymer; and discharging the resulting epoxidized elastomeric polymer from the mixing device.

The present invention relates to a process for producing an epoxidized elastomeric polymer.

Processes for producing epoxidized elastomeric polymers are already known in the art.

For example, patent GB 1,528,932 relates to a process for producing epoxidized 1,2-polybutadiene, which comprises reacting a solution of amorphous 1,2-polybutadiene having a viscosimetric molecular weight higher than 20,000, containing at least 50% of 1,2-added units and having a crystallinity at 20° C. lower than 5%, with a monoperphthalic acid solution in an amount sufficient to obtain the desired degree of epoxidation, removing the phthalic acid formed during the reaction and separating the epoxidized 1,2-polybutadiene so obtained. The abovementioned epoxidation process is said to give a 1,2-polybutadiene with different epoxidazion rates, e.g. from 3% to 80% so as to obtain, from the same starting product, a large variety of materials having particular properties and including both elastomers and resin fields.

Patent application GB 2,113,692 discloses a method of making epoxidized cis-1,4-polyisoprene rubber from natural or synthetic cis-1,4-polyisoprene latex comprising reacting the rubber latex stabilized against coagulation by a non-ionic surfactant, with performic acid or peracetic acid formed in situ, coagulating the latex by heating to a temperature above the cloud-point of the surfactant, adding base to the rubber, and throughly washing the coagulum to remove substantially all residual reactants and modified non-rubbers. The performic acid or peracetic acid are formed in situ starting from hydrogen peroxide and formic or acetic acid. The amount of the hydrogen peroxide used in the reaction to form the peracid in situ depends mainly on the desired degree of epoxidazion which is said to be, typically, from 5% to 75% of the theoretical maximum.

U.S. Pat. No. 4,851,556 relates to a process for the preparation of epoxidized polybutadienes having an average molecular weight of 500 to 100,000 and a content of 1 to 20 weight percent of epoxide oxygen per 100 g of diene polymer, said process comprising reacting a polybutadiene with a solution of a perpropionic acid at a concentration of 10-30% by weight in benzene at a molar ratio of 1:1 to 1:1.3 (double bond to be epoxidized to perpropionic acid) at a temperature of 10° C. to 100° C., preferably 20° C. to 50° C., removing the benzene, the propionic acid, the unreacted perpropionic acid and the other volatile components by distillation and desorption, and isolating the epoxidized polybutadiene so obtained. The preferred degree of epoxidation is said to be from 5% to 50%, more preferably from 20% to 40%.

However, the above disclosed processes may show some drawbacks. Firstly, the use of reactants such as, hydrogen peroxide and peracids, may cause handling and storage problems due to the instability of said products. Moreover, both hydrogen peroxide and peracids may cause corrosion phenomena of the metering and storage devices. Furthermore, use of solvents or latexes require additional processing steps such as elimination of the solvents from the final product or a re-coagulation step.

In order to avoid the use of solvents or latexes, in recent years, solventless reactive processes have been proposed in manufacturing rubber.

For example, Zhang et al., in “Journal of Applied Polymer Science”, Vol. 81, pg. 2987-2992, (2001), John Wiley & Sons Ed., discloses the epoxidation of high cis-butadiene rubber (BR) with monoperoxy phthalic acid which is carried out in a reactive processing equipment (Haake mixer), at room temperature. The monoperoxy phthalic acid was previously synthesized starting from phthalic anhydride and hydrogen peroxide.

However, the drawbacks above disclosed relative to the use of hydrogen peroxide and peracids remain still unsolved.

The Applicant has now found that it is possible to overcome the above reported drawbacks by a process for producing epoxidized elastomeric polymers which uses as epoxidizing agent a combination of a hydrogen peroxide precursor and a carboxylic acid or a derivative thereof. In particular the Applicant has found that the use of said hydrogen peroxide precursor and said carboxylic acid or a derivative thereof, in the presence of water, allows to obtain an effective epoxidazion of the elastomeric polymer and to avoid the handling and storage problems above mentioned.

Moreover, the Applicant has found that the above process allows to control the amount of the epoxy groups introduced into the elastomeric polymer so as to obtain an epoxidized elastomeric polymer with a low epoxidation rate. As a matter of fact, said process allows to obtain epoxidized elastomeric polymers containing less than 10 mol % of epoxy groups relative to the total number of moles of monomers present in the elastomeric polymers.

According to a first aspect, the present invention relates to a process for producing an epoxidized elastomeric polymer comprising:
feeding at least one elastomeric polymer containing ethylenic unsaturations to a mixing device;
feeding at least one hydrogen peroxide precursor to said mixing device;
feeding at least one carboxylic acid or a derivative thereof to said mixing device;
mixing and reacting, in the presence of water, said at least one elastomeric polymer containing ethylenic unsaturations, with said at least one hydrogen peroxide precursor and said at least one carboxylic acid or a derivative thereof, to obtain an epoxidized elastomeric polymer;
discharging the resulting epoxidized elastomeric polymer from said mixing device.

For the purposes of the present description and of the claims which follows, the term “hydrogen peroxide precursor” means a compound which, in the presence of water and/or by thermal decomposition, releases hydrogen peroxide.

Preferably, the mixing device may be selected from: open internal mixers such as, for example, open-mills; internal mixers such as, for example, Haake Rheocord internal mixer, or internal mixers of the type with tangential rotors (Banbury) or with interlocking rotors (Intermix); continuous mixers of Ko-Kneader type (Buss); co-rotating or counter-rotating twin-screw extruders. More preferably, the mixing device is a co-rotating twin-screw extruder.

Preferably, said at least one elastomeric polymer containing ethylenic unsaturations is fed to the mixing device in a solid form (e.g. in granular form).

Preferably, said at least one hydrogen peroxide precursor is fed to the mixing device in a solid form (e.g. in granular form or in powder form).

According to one preferred embodiment, said process may be advantageously carried out in the presence of at least one non-ionic surfactant.

According to a further preferred embodiment, said process may be advantageously carried out in the presence of at least one stabilizing agent.

According to one preferred embodiment, said process may be carried out at a temperature of between 15° C. and 200° C., preferably of between 50° C. and 180° C.

According to one preferred embodiment, said process may be carried out for a time of between 10 seconds and 30 minutes, preferably between 30 seconds and 20 minutes.

The epoxidized elatomeric polymer obtained from the process according to the present invention, contains less than 10 mol % of epoxy groups relative to the total number of moles of monomers present in the elastomeric polymer. Preferably, said epoxidized elastomeric polymer contains from 0.1 mol % to 5 mol % of epoxy groups relative to the total number of moles of monomers present in the elastomeric polymer.

The amount of the epoxy groups present on the obtained elastomeric polymers may be determined according to known techniques. For example, the obtained epoxidized elastomeric polymers may be analyzed by ¹H-NMR analysis, or by hydrolysis of the epoxy groups and subsequent functionalization of the obtained hydroxyl groups by agent which are active to UV fluorescence analysis.

With regard to the elastomeric polymer containing ethylenic insaturations, said ethylenic unsaturations may be either in the main chain, or in the side chain of the elastomeric polymer, or in both. Consequently, the obtained epoxidized elastomeric polymer will contain epoxy groups in its main chain and/or in its side chain.

According to one preferred embodiment, the elastomeric polymer containing ethylenic unsaturations may be selected from diene homopolymers or copolymers having a glass transition temperature (T_{g}) generally below 20° C., preferably in the range of from 0° C. to −110° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight. In the case of copolymers, these can have a random, block, grafted or mixed structure.

The conjugated olefins generally contain from 4 to 12, preferably from 4 to 8, carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-Butadiene and isoprene are particularly preferred.

Monovinylarenes which may optionally be used as comonomers generally contain from 8 to 20, preferably from 8 to 12, carbon atoms, and may be selected, for example, from: styrene; 1-vinylnaphthalene; 2-vinyl-naphthalene; various alkyl, cycloalkyl, aryl, alkylaryl or arylalkyl derivatives of styrene such as, for example: α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred. These monovinylarenes can optionally be substituted with one or more functional groups, such as alkoxy groups, for example 4-methoxystyrene.

Polar comonomers which may optionally be used may be selected, for example, from: vinylpyridine, vinylquinoline, acrylic and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the elastomeric polymer containing ethylenic unsaturations which may be used in the present invention may be selected, for example, from: cis-1,4-polyisoprene (natural or synthetic, preferably natural rubber), 3,4-polyisoprene, polybutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof. Natural rubber, polybutadiene, and styrene/1,3-butadiene copolymers, are particularly preferred.

According to a further preferred embodiment, said elastomeric polymer containing ethylenic unsaturations, may be selected from elastomeric polymers of one or more monoolefins with an olefinic comonomer and at least one diene, or derivatives thereof. The monoolefins may be selected from: ethylene and α-olefins generally containing from 3 to 12 carbon atoms, such as, for example, propylene, 1-butene, 1-pentene, 1-hexene, 1-octene, or mixtures thereof. The following are preferred: copolymers of ethylene and of an α-olefin and at least one diene, isobutene homopolymers or copolymers thereof with small amounts of a diene, which may be at least partially halogenated. The diene generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the ones that are particularly preferred are: ethylene/propylene/diene copolymers (EPDM); polyisobutene; butyl rubbers; halobutyl rubbers, in particular chlorobutyl or bromobutyl rubbers; or mixtures thereof.

The average molecular weight of the diene elastomeric polymer containing ethylenic unsaturations is, preferably, between 2000 and 1,000,000, preferably between 50,000 and 500,000. Said average molecular weight may be determined according to known techniques such as, for example, by gel permeation chromatography (GPC).

According to one preferred embodiment, the hydrogen peroxide precursor may be selected from:
(a) inorganic persalts;
(b) metal peroxides;
(c) hydrogen peroxide adducts.

Specific examples of inorganic persalts (a) which may be used according to the present invention, are:
boron compounds such as, for example: perborates, such as, for example, sodium perborate hexahydrate of the formula Na₂[B(O₂)₂(OH)₄].6H₂O (also identified as sodium perborate tetrahydrate of the formula NaBO₃.4H₂O); sodium peroxyborate tetrahydrate of the formula Na₂B₂(O₂)₂ (OH) ₄].4H₂O (also identified as sodium perborate trihydrate of the formula NaBO₃.3H₂O); sodium peroxyborate of the formula Na₂[B₂(O₂)₂(OH)₄].4H₂O (also identified as sodium perborate monohydrate of the formula NaBO₃.H₂O); or mixtures thereof; sodium perborate mono- and tetrahydrate are preferred;
alkali metal percarbonates such as, for examples, sodium percarbonate (sodium carbonate peroxyhydrate); potassium percarbonate; rubidium percarbonate; cesium percarbonate; or mixtures thereof; sodium percarbonate is preferred;
persulfuric salts such as, for example, sodium persulfate, potassium peroxymonosulfate (also identified as potassium monopersulfate); or mixtures thereof; potassium peroxymonosulfate is preferred.

Specific examples of metal peroxides (b) which may be used according to the present invention, are: lithium peroxide, sodium peroxide, magnesium peroxide, calcium peroxide, strontium peroxide, barium peroxide, zinc peroxide, or mixtures thereof. Magnesium peroxide, calcium peroxide and zinc peroxide are preferred.

Specific examples of hydrogen peroxide adducts (c) which may used according to the present invention are: urea/hydrogen peroxide adduct, polyvinyl pyrrolidone/hydrogen peroxide adduct, or mixtures thereof. Urea/hydrogen peroxide adduct is preferred.

Hydrogen peroxide precursors which may be used according to the present invention and are available commercially are the products known by the name of Oxyper® from Solvay and Oxone® from DuPont.

According to one preferred embodiment, the hydrogen peroxide precursor (b) is added to the process of the present invention in an amount of from 0.1 phr to 50 phr, preferably from 0.5 phr to 20 phr.

For the purposes of the present description and of the claims which follows, the term “phr” means the parts by weight of a given component per 100 parts by weight of the elastomeric polymer containing ethylenic unsaturations.

According to one preferred embodiment, the carboxylic acid may be selected from monocarboxylic acids or dicarboxylic acids.

Preferably, the monocarboxylic acids have the following general formula (I):
R—COOH (I)
wherein R represents a linear or branched C₁-C₁₂ alkyl group; a C₆-C₁₈ aryl group; a C₇-C₂₀ arylalkyl or alkylaryl group; a C₅-C₁₈ cycloalkyl group.

Preferably, the dicarboxylic acids have the following general formula (II):
HOOC—R₁—COOH (II)
wherein R₁ represents a linear or branched C₁-C₁₂. alkylene group; a linear or branched C₂-C₁₂ alkenylene group; a C₆-C₁₈ arylene group; a C₇-C₂₀ alkylarylene or alkylenearylene group; a C₆-C₂₀ cycloalkylene group.

Specific examples of R groups are: methyl, ethyl, propyl, isopropyl, butyl, t-butyl, isobutyl, pentyl, hexyl, octyl, allyl, methallyl, 2-butenyl, propenyl, hexenyl, octenyl, benzyl, phenyl, naphthyl, methylbenzyl, ethylbenzyl, diphenyl, methylphenyl, ethylphenyl, methylnaphthyl, ethylnaphtyhl, cyclopentyl, cyclohexyl.

Specific examples of R₁ groups are: methylene, ethylene, propylene, butylene, 2,2-dimethyl-1,3-propylene, hexylene, 2-methyl-3-ethyl-1,4-butylene, octylene, vinylene, butenylene, isobutenylene, pentenylene, hexenylene, phenylene, naphthylene, diphenylene, benzenylene, phenylmethylene, phenylethylene, naphthylmethylene, naphthylethylene, methylphenylene, ethylphenylene, methylnaphthylene, ethylnaphthylene, cyclopentenylene, cyclohexylene.

According to one preferred embodiment, the carboxylic acid derivative may be selected from esters, anhydrides, halides, imides, amides, or mixtures thereof.

Anhydrides, such as acetic anhydride, maleic anhydride, succinic anhydride, phthalic anhydride, or mixtures thereof, are preferred.

According to one preferred embodiment, the carboxylic acid or a derivative thereof are added to the process of the present invention in an amount of from 0.1 phr to 50 phr, preferably from 0.5 phr to 20 phr.

As reported above, in order to improve the dispersion of the hydrogen peroxide precursor and of the carboxylic acid or a derivative thereof in the elastomeric polymer containing ethylenic unsaturations, a non-ionic surfactant may be optionally added.

According to one preferred embodiment, a non-ionic surfactant may be selected, for example, from those having a polyalkylene oxide polymer as a portion of the surfactant molecule. Such non-ionic surfactants include, for example, chlorine-, benzyl-, methyl-, ethyl-, propyl-, butyl-, and other like alkyl-capped polyethylene and/or polypropylene glycol ethers of fatty alcohols; polyalkylene oxides free non-ionic such as, for example, alkyl polyglycosides; polyol esters such as sorbitan esters, sucrose esters, or pentaerythritol esers and their ethoxylates, such as, for example, pentaerythritol pentaethoxylated; alkoxylated ethylene diamines; carboxylic acid esters such as, for example, glycerol esters, polyoxyethylene esters, ethoxylated and glycol esters of fatty acids; carboxylic amides such as, for example, diethanolamine condensates, monoalkanolamine condensates polyoxyethylene fatty acid amides; ethoxylated amines and ether amines; or mixtures thereof.

Additional suitable non-ionic surfactants having a polyalkylene oxide polymer portion include non-ionic surfactants of C₆-C₂₄, preferably C₆-C₁₄, alcohol ethoxylates, having from 1 to about 20, preferably from about 9 to about 20, ethylene oxide groups; C₆-C₂₄, preferably C₈-C₁₀ alkylphenol ethoxylates, having from 1 to about 100, preferably from about 12 to about 20, ethylene oxide groups; C₆-C₂₄, preferably C₆-C₂₀, alkylpolyglycosides, having from 1 to about 20, preferably from about 9 to about 20, glycoside groups; C₆-C₂₄ fatty acid ester ethoxylates, propoxylates, or glycerides; C₄-C₂₄ mono or dialkanolamides; or mixtures thereof.

Specific alcohol alkoxylates include alcohol ethoxylate propoxylates, alcohol propoxylates, alcohol propoxylate ethoxylate propoxylates, alcohol ethoxylate butoxylates, or mixtures thereof; nonylphenol ethoxylate, polyoxyethylene glycol ethers, or mixtures thereof; polyalkylene oxide block copolymers including an ethylene oxide/propylene oxide block copolymer such as those commercially available under the name of Pluronic® from Basf, or mixtures thereof.

According to one preferred embodiment, the non-ionic surfactant is added to the process of the invention in an amount of from 0 phr to 20 phr, preferably from 0.1 phr to 10 phr.

Non-ionic surfactant which may be used according to the present invention and is available commercially is the product known by the name of Polyol® PP50 from Perstorp.

As reported above, in order to avoid a possible degradation of the obtained epoxidized elastomeric polymer (for example, during storage), at least one stabilizing agent may be optionally added.

According to one preferred embodiment, the stabilizing agent may be selected from sterically hindered phenols, sterically hindered amines (HALS), amine derivatives, dihydroquinoline derivatives, or mixtures thereof.

Specific examples of sterically hindered phenols which may be advantageously used according to the present invention are: tetrakis[3-(3,5-di-t-butyl-4-hydroxyphenyl)propionyloxymethyl]methane (Irganox® 1010 from Ciba Geigy or Anox® 20 from Great Lakes), octadecyl-3-(3′,5′-di-t-butyl-4′-hydroxyphenyl)-propionate (Irganox® 1076 from Ciba Geigy or Anox® PP18 from Great Lakes), 1,3,5-trimethyl-2,4,6-tris(3,5-di-t-butyl-4-hydroxybenzyl)benzene (Irganox® 1330 from Ciba Geigy), or mixtures thereof.

Specific examples of sterically hindered amines which may be advantageously used according to the present invention are: bis(2,2,6,6-tetramethyl-4-piperidyl)sebacate (Tinuvin® 770 from Ciba Geigy or Uvasebo 770 from Great Lakes), poly(N-β-hydroxyethyl)-2,2,6,6-tetramethyl-4-hydroxy-piperidylsuccinate (Tinuvin® 622 from Ciba Geigy) or mixtures thereof.

Specific examples of amine derivatives which may be advantageously used according to the present invention are: N-isopropyl-N′-phenyl-p-phenylenediamine (IPPD), N-(1,3-dimethylbutyl)-N′-p-phenylenediamine (6PPD), N,N′-bis(1,4-dimethylpentyl)-p-phenylenediamine (77PD), N,N′-bis(1-ethyl-3-methylpentyl)-p-phenyldiamine (DOPD), N,N′-diphenyl-p-phenylenediamine (DPPD), N,N′-ditolyl-p-phenylenediamine (DTPD), N,N′-di-β-naphthyl-p-phenylenediamine (DNPD), phenyl-α-naphthylamine (PAN) and phenyl-β-naphthylamine (PBN), or mixtures thereof.

Specific examples of dihydroquinoline derivatives which may be advantageously used according to the present invention are: 2,2,4-trimethyldihydroquinoline, 6-ethoxy-2,2,4-trimethyl-1,2-dihydroquinoline (ETMQ), or mixtures thereof.

According to one preferred embodiment, the stabilizing agent is added to the process of the invention in an amount of from 0 phr to 10 phr, preferably from 0.1 phr to 5 phr.

Generally, the elastomeric polymer containing ethylenic unsaturations, the hydrogen peroxide precursor, and the carboxylic acid or a derivative thereof, are fed simultaneously to a mixing device.

As reported above, the process according to the present invention is carried out in the presence of water.

According to one preferred embodiment, the process of the invention is carried out in the presence of water in an amount of from 0.1 phr to 50 phr, preferably from 0.5 phr to 20 phr.

The water may be added one-shot or stepwise during the process of the present invention.

For example, a small amount of water (for example, not more than 20% of the total amount of water) may be added to the mixing device together with the elastomeric polymer containing ethylenic unsaturations, the hydrogen peroxide precursor and the carboxylic acid or a derivative thereof, the remaining part of water being added after having well dispersed the hydrogen peroxide precursor and the carboxylic acid or a derivative thereof into the elastomeric polymer containing ethylenic unsaturations.

Alternatively, all the water amount may be added to the mixing device after having well dispersed the hydrogen peroxide precursor and the carboxylic acid or a derivative thereof into the elastomeric polymer containing ethylenic unsaturations.

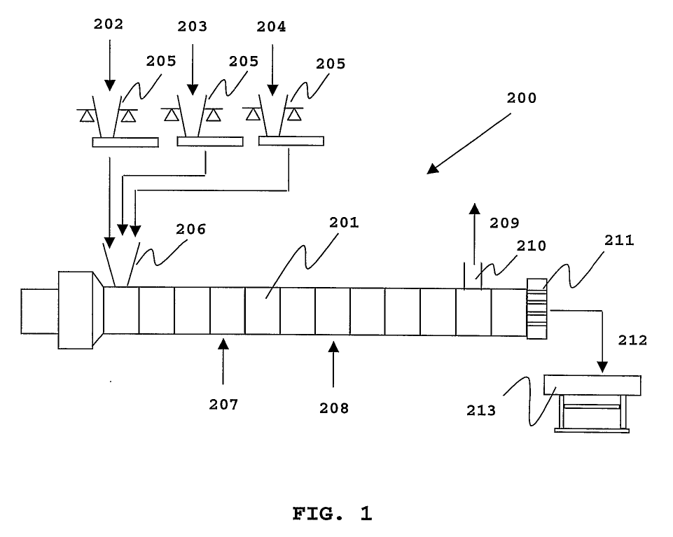

The present invention will now be illustrated in further detail by means of an illustrative embodiment, with reference to the attached FIG. 1.

FIG. 1 is a schematic diagram of a production plant for carrying out the process of the present invention.

With reference to FIG. 1, the production plant (200) includes an extruder (201) suitable for carrying out the process of the present invention. As schematically shown in FIG. 1, by means of a feed hopper (206) the extruder (201) is fed with the compounds necessary for producing the epoxidized elastomeric polymer. Preferably, the extruder is a co-rotating twin screw extruder.

Generally, the compounds are fed simultaneously to the extruder. For example, the elastomeric polymer containing ethylenic unsaturations (202), the hydrogen peroxide precursor (203), the carboxylic acid or a derivative thereof (204), and the other components optionally present (i.e. surfactant, stabilizing agent), are fed to the extruder (201) through the same feed hopper (206). Alternatively, the compounds may be fed to the extruder (201) through different feed hoppers (not represented in FIG. 1).

Before being fed to feed hopper (206), the elastomeric polymer containing ethylenic unsaturations (202), which is usually provided by manufacturers in bales, is comminuted in irregular particles (crumbs) of small size (about 3 mm-15 mm as average dimensions), e.g. by of a rubber grinding (not represented in FIG. 1). The rubber crumbs may be then supplemented with an antisticking agent (e.g. chalk, silica, or other powders) to avoid reagglomeration.

Each flow (202), (203), and (204) is fed to the feed hopper (206) by means of different metering devices (205). Preferably said metering devices are loss-in-weight gravimetric feeders. Alternatively, each flow (202), (203) and (204) may be fed to the feed hopper (206) by means of the same metering device (205).

Alternatively, the carboxilic acid or a derivative thereof (204) may be in a molten state and may be injected to the extruder. (201) by means of a gravimetrically controlled feeding pump (not represented in FIG. 1).

The non-ionic surfactant optionally present, may be injected to the extruder (201) by means of a gravimetrically controlled feeding pump (not represented in FIG. 1) or by means of a metering device (205).

The water may be injected to different extruder zones (207, 208) by means of gravimetrically controlled feeding pumps (not represented in FIG. 1). Alternatively, a small amount of water (for example, not more than 20% of the total amount of water), may be added through the feed hopper (206) together with the elastomeric polymer containing ethylenic unsaturations, the hydrogen peroxide precursor and the carboxylic acid or a derivative thereof.

FIG. 1 shows also a degassing unit schematically indicated by reference sign (210) from which a flow of the gases possibly generated during extrusion (209) exits.

The resulting epoxidized polymer (212) is discharged from the extruder (201), e.g. in the form of a continuous strand, by pumping it through a rectangular extruder die (211) and is conveyed to a cooling device (212). A gear pump (not represented in FIG. 1) may be provided before said extruder die (211). After cooling, the resulting epoxidized polymer may be granulated by means of a grinding device (not represented in FIG. 1).

Alternatively, the resulting epoxidized polymer (212) is discharged from the extruder (201) in the form of a subdivided product by pumpimg it through an extruder die (210) which may be provided with a perforated die plate equipped with knives (not represented in FIG. 1). The obtained subdivided product may be, e.g. in a granular form, with an average diameter of the granules generally of between 0.5 mm and about 3 mm, preferably between 1 mm and 2 mm, and a length generally between about 1 mm and 4 mm, preferably between 1.5 mm and 3 mm.

The obtained epoxidized elastomeric polymer may be advantageously used in crosslinkable elastomeric compositions, in particular in sulphur crosslinkable elastomeric compositions. Said elastomeric compositions may be advantageously used in the manufacturing of crosslinked elastomeric products such as, for example, tyre for vehicle wheels, conveyor belts, driving belts, or flexible tubes.

The present invention will be further illustrated below by means of a number of preparation examples, which are given for purely indicative purposes and without any limitation of this invention.

### EXAMPLE 1

Preparation of the Epoxidized Polymer in an Internal Mixer

The epoxidized polymer was prepared as follows. 100 g of cis-1,4-polybutadiene (Europrene Neocis® BR 40—Polimeri Europa) were fed to a Haake Rheocord internal mixer having 200 ml volume and was heated at 70° C., for 2 min, at 55 rpm.

Subsequently, 8.93 g of succinic anhydride (from Lonza), 10.62 g of pre-grinded sodium percarbonate (Oxyper® 131S from Solvay), and 5.00 g of pentaerythritol pentaethoxylated (Polyol® PP50 from Perstorp), were added: the mixture was maintained at 70° C., for 3 min, at 55 rpm.

Subsequently, 10. 62 g of water were added in the Haake mixer: the mixture was maintained at 70° C., for 3 min, at 55 rpm.

The epoxidized polymer was discharged from the mixer and a sample of the same was subjected to UV fluorescence analysis below reported in order to evaluate the amount of the epoxy groups. The obtained data are given in Table 2.

### EXAMPLE 2-4

Preparation of the Epoxidized Polymer in a Twin-Screw Extruder

The epoxidized polymer was prepared as follows by using a production plant as reported in FIG. 1.

The amounts of the compounds used are given in Table 1 (the amounts of the various components are given in phr).

TABLE 1

| | EXAMPLE | | |
|---|---|---|---|
| | 2 | 3 | 4⁽*⁾ |
| SBR | 100 | 100 | 100 |
| succinic anhydride | 3.60 | 7.20 | — |
| sodium percarbonate | 4.28 | 8.57 | — |
| water | 4.28 | 8.57 | — |

⁽*⁾comparative.
SBR: styrene/butadiene copolymer, obtained by solution polymerization, containing 36% by weight of styrene, mixed with 37.5% of oil (HP 752 ® - JSR Polymer);
succinic anhydride: commercial product from Lonza;
sodium percarbonate: Oxyper ® 131S from Solvay.

The SBR rubber copolymer was obtained in the form of granules having an average particles size diameter of about 3 mm-15 mm, by means of a rubber grinder. The so obtained granules, the succinic anhydride and the sodium percarbonate, both in granular form, were fed to the feed hopper of a co-rotating twin-screw extruder Maris TM40HT having a nominal screw diameter of 40 mm and a L/D ratio of 48.

The feeding was carried out by means of three loss-in-weight gravimetric feeders.

The water was added by means of two gravimetrically controlled feeding pumps (not represented in FIG. 1) in two different extruder zones.

The temperature profile in the zones of the extruder was the following:
Z₁=30° C.;
Z₂=180° C.;
Z₃=180° C.;
Z₄=100° C.;
Z₅=100° C.;
Z₆=100° C.;
Z₇=50° C.;
Z₈=20° C.;
Z₉=20° C.;
Z₁₀=20° C.;
Z₁₁=20° C.;
Z₁₂=20° C.;

The extrusion head was kept at a temperature of 55° C.

The remaining working conditions were the following:
twin screw speed: 400 rpm;
feeding rate: 40 kg/h;
mechanical energy delivered to the system: 0.270 kWh/kg.

The epoxidized polymer was discharged from the extruder in the form of a continuous strand, was cooled at room temperature and granulated. A sample of the obtained epoxidized polymer was subjected to UV fluorescence analysis below reported in order to evaluate the amount of the epoxy groups. The obtained data are given in Table 2.

UV Fluorescence Analysis

The epoxidized elastomeric polymers obtained according to Examples 1-3 and the elastomeric polymer obtained according to Example 4 (comparative example), were grounded into granules having an average particles size diameter of about 1 mm, by means of a rubber grinder.

The obtained granules were washed with water by means of a Soxhlet apparatus, in order to hydrolize the epoxy groups and to eliminate the reaction by-products. Subsequently, the granules were dried in an oven, at 70° C., for about 12 hours.

The dried granules (300 mg) were dissolved into 10 ml of anhydrous pyridine and were heated at 80° C., under stirring, for 30 min. Subsequently, 120 mg of 4-bromoethyl-6,7-dimethoxycoumarin, were added and the solution was maintained at 80° C., under stirring, for 6 hours.

Afterward, the solution was cooled at room temperature and 30 ml of methanol were gentle added: the obtained precipitated polymer was washed in methanol twice and dried in an oven, at 70° C., for about 12 hours.

To 20 mg of the above dried polymer, 5 ml of toluene were added and the obtained solution was heated under gentle reflux, under stirring, for 2 hours, at 80° C. Subsequently, the solution was diluted with hexane and subjected to UV fluorescence analysis by means of spectrometer Jaswco A 235.

The amount of the epoxy groups was obtained by the signal at 320 nm in comparison to a calibration curve derived from 4-carboxymethyl-7-methoxycumarin. The amount of the epoxy groups was calculated by the following formula:

$$mol \% = \frac{A / B}{2} \times 100$$

wherein A is the concentration of the fluorescent groups and B is the concentration of the elastomeric polymers.

It has to be noted that, the above analysis, evaluate also the presence of groups which may result from the decomposition of the epoxy groups such as, for example, vicinal diols or ester groups.

The data given in Table 2 were the average of the data obtained from the analysis conducted on four samples of each epoxidized polymer.

TABLE 2

| | AMOUNT OF EPOXIDIZED GROUPS |
|---|---|
| EXAMPLE | (mol %) |
| 1 | 1.7 ± 0.1 |
| 2 | 0.6 ± 0.2 |
| 3 | 1.8 ± 0.3 |
| 4⁽*⁾ | <0.1 |

⁽*⁾comparative.

1-41. (canceled)

42. A process for producing an epoxidized elastomeric polymer comprising:
feeding at least one elastomeric polymer containing ethylenic unsaturation to a mixing device;
feeding at least one hydrogen peroxide precursor to said mixing device;
feeding at least one carboxylic acid or a derivative thereof to said mixing device;
mixing and reacting, in the presence of water, said at least one elastomeric polymer containing ethylenic unsaturations, with said at least one hydrogen peroxide precursor and said at least one carboxylic acid or a derivative thereof, to obtain an epoxidized elastomeric polymer; and
discharging the resulting epoxidized elastomeric polymer from said mixing device.

43. The process for producing an epoxidized elastomeric polymer according to claim 42, wherein the mixing device is selected from: open internal mixers; internal mixers, continuous mixers of the Ko-Kneader type; and co-rotating or counter-rotating twin-screw extruders.

44. The process for producing an epoxidized elastomeric polymer according to claim 43, wherein the mixing device is a co-rotating twin-screw extruder.

45. The process for producing an epoxidized elastomeric polymer according to claim 42, wherein the elastomeric polymer containing ethylenic unsaturation is fed to the mixing device in a solid form.

46. The process for producing an epoxidized elastomeric polymer according to claim 42, wherein the hydrogen peroxide precursor is fed to the mixing device in a solid form.

47. The process for producing an epoxidized elastomeric polymer according to claim 42, wherein said process is carried out at a temperature of 15° C. to 200° C.

48. The process for producing an epoxidized elastomeric polymer according to claim 47, wherein said process is carried out at a temperature of 50° C. to 180° C.

49. The process for producing an epoxidized elastomeric polymer according to claim 42, wherein said process is carried out for 10 seconds to 30 minutes.

50. The process for producing an epoxidized elastomeric polymer according to claim 49, wherein said process is carried out for 30 seconds to 20 minutes.

51. The process for producing an epoxidized elastomeric polymer according to claim 42, wherein the epoxidized elastomeric polymer contains less than 10 mol % of epoxy groups relative to the total number of moles of monomers present in the elastomeric polymer.

52. The process for producing an epoxidized elastomeric polymer according to claim 51, wherein the epoxidized elastomeric polymer contains 0.1 mol % to 5 mol % of epoxy groups relative to the total number of moles of monomers present in the elastomeric polymer.

53. The process for producing an epoxidized elastomeric polymer according to claim 42, wherein the elastomeric polymer containing ethylenic unsaturation is selected from diene homopolymers or copolymers having a glass transition temperature below 20° C.

54. The process for producing an epoxidized elastomeric polymer according to claim 53, wherein the elastomeric polymer containing ethylenic unsaturation is selected from: cis-1,4-polyisoprene, 3,4-polyisoprene, polybutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

55. The process for producing an epoxidized elastomeric polymer according to claim 42, wherein the elastomeric polymer containing ethylenic unsaturation is selected from elastomeric polymers of one or more monoolefins with an olefinic comonomer and at least one diene, or derivatives thereof.

56. The process for producing an epoxidized elastomeric polymer according to claim 55, wherein the elastomeric polymer containing ethylenic unsaturation is selected from: ethylene/propylene/diene copolymers; polyisobutene; butyl rubbers; halobutyl rubbers; or mixtures thereof.

57. The process for producing an epoxidized elastomeric polymer according to claim 42, wherein the elastomeric polymer containing ethylenic unsaturation has an average molecular weight of 2000 to 1,000,000.

58. The process for producing an epoxidized elastomeric polymer according to claim 42, wherein the hydrogen peroxide precursor is selected from:
(a) inorganic persalts;
(b) metal peroxides; or
(c) hydrogen peroxide adducts.

59. The process for producing an epoxidized elastomeric polymer according to claim 58, wherein the inorganic persalts are selected from:
boron compounds, perborates, said perborates being selected from: sodium perborate hexahydrate of the formula Na₂[B(O₂)₂(OH)₄].6H₂O (also defined as sodium perborate tetrahydrate of the formula NaBO₃.4H₂O); sodium peroxyborate tetrahydrate of the formula Na₂B₂(O₂)₂[(OH)₄].4H₂O (also defined as sodium perborate trihydrate the formula NaBO₃.3H₂O); sodium peroxyborate of the formula Na₂[B₂(O₂)₂[(OH)₄].4H₂O (also defined as sodium perborate monohydrate of the formula NaBO₃.H₂O); or mixtures thereof;
alkali metal percarbonates, sodium percarbonate (sodium carbonate peroxyhydrate); potassium percarbonate; rubidium percarbonate; cesium percarbonate; or mixtures thereof; and
persulfuric salts, sodium persulfate, potassium peroxymonosulfate (also defined as potassium monopersulfate); or mixtures thereof.

60. The process for producing an epoxidized elastomeric polymer according to claim 58, wherein the metal peroxides are selected from: lithium peroxide, sodium peroxide, magnesium peroxide, calcium peroxide, strontium peroxide, barium peroxide, zinc peroxide, or mixtures thereof.

61. The process for producing an epoxidized elastomeric polymer according to claim 58, wherein the hydrogen peroxide adducts are selected from: urea/hydrogen peroxide adduct, polyvinyl pyrrolidone/hydrogen peroxide adduct, or mixtures thereof.

62. The process for producing an epoxidized elastomeric polymer according to claim 42, wherein a hydrogen peroxide precursor is added in an amount of 0.1 phr to 50 phr.

63. The process for producing an epoxidized elastomeric polymer according to claim 62, wherein the hydrogen peroxide precursor is added in an amount of 0.5 phr to 20 phr.

64. The process for producing an epoxidized elastomeric polymer according to claim 42, wherein the carboxylic acid is selected from monocarboxylic acids or dicarboxylic acids.

65. The process for producing an epoxidized elastomeric polymer according to claim 64, wherein the monocarboxylic acids have the following general formula (I):
R—COOH (I)
wherein R represents a linear or branched C₁-C₁₂ alkyl group; a C₆-C₁₈ aryl group; a C₇-C₂₀ arylalkyl or alkylaryl group; or a C₅-C₁₈ cycloalkyl group.

66. The process for producing an epoxidized elastomeric polymer according to claim 64, wherein the dicarboxylic acids have the following general formula (I):
HOOC—R₁—COOH (II)
wherein R₁ represents a linear or branched C₁-C₁₂ alkylene group; a linear or branched C₂-C₁₂ alkenylene group; a C₆-C₁₈ arylene group; a C₇-C₂₀ alkylarylene or alkylenearylene group; or a C₆-C₂₀ cycloalkylene group.

67. The process for producing an epoxidized elastomeric polymer according to claim 42, wherein the carboxylic acid derivative is selected from esters, anhydrides, halides, imides, amides, or mixtures thereof.

68. The process for producing an epoxidized elastomeric polymer according to claim 67, wherein the carboxylic acid derivative is selected from anhydrides, maleic anhydride, succinic anhydride, phthalic anhydride, or mixtures thereof.

69. The process for producing an epoxidized elastomeric polymer according to claim 42, wherein the carboxylic acid or a derivative thereof is added in an amount of 0.1 phr to 50 phr.

70. The process for producing an epoxidized elastomeric polymer according to claim 69, wherein the carboxylic acid or a derivative thereof is added in an amount of 0.5 phr to 20 phr.

71. The process for producing an epoxidized elastomeric polymer according to claim 42, wherein at least one non-ionic surfactant is added.

72. The process for producing an epoxidized elastomeric polymer according to claim 71, wherein the non-ionic surfactant is selected from those having a polyalkylene oxide polymer as a portion of the surfactant molecule, chlorine-, benzyl-, methyl-, ethyl-, propyl-, butyl-, and other like alkyl-capped polyethylene and/or polypropylene glycol ethers of fatty alcohols, polyalkylene oxide-free non-ionic, alkyl polyglycosides, polyol esters, sorbitan esters, sucrose esters, pentaerythritol esters and their ethoxylates, alkoxylated ethylene diamines, carboxylic acid esters, glycerol esters, polyoxyethylene esters, ethoxylated and glycol esters of fatty acids, carboxylic amides, ethoxylated amines and ether amines, or mixtures thereof.

73. The process for producing an epoxidized elastomeric polymer according to claim 71, wherein the non-ionic surfactant is selected from C₆-C₂₄ alcohol ethoxylates having from 1 to about 20 ethylene oxide groups; C₆-C₂₄ alkylphenol ethoxylates having from 1 to about 100 ethylene oxide groups; C₆-C₂₄ alkylpolyglycosides having from 1 to about 20 glycoside groups; C₆-C₂₄ fatty acid ester ethoxylates, propoxylates, or glycerides; C₄-C₂₄ mono or dialkanolamides; or mixtures thereof.

74. The process for producing an epoxidized elastomeric polymer according to claim 71, wherein the non-ionic surfactant is selected from alcohol alkoxylates, alcohol ethoxylate propoxylates, alcohol propoxylates, alcohol propoxylate ethoxylate propoxylates, alcohol ethoxylate butoxylates, or mixtures thereof; nonylphenol ethoxylate, polyoxyethylene glycol ethers, or mixtures thereof; polyalkylene oxide block copolymers, an ethylene oxide/propylene oxide block copolymer, or mixtures thereof.

75. The process for producing an epoxidized elastomeric polymer according to claim 71, wherein the non-ionic surfactant is added in an amount of 0 phr to 20 phr.

76. The process for producing an epoxidized elastomeric polymer according to claim 75, wherein the non-ionic surfactant is added in an amount of 0.1 phr to 10 phr.

77. The process for producing an epoxidized elastomeric polymer according to claim 42, wherein at least one stabilizing agent is added.

78. The process for producing an epoxidized elastomeric polymer according to claim 77, wherein the stabilizing agent is selected from hindered phenols, sterically hindered amines, amine derivatives, dihydroquinoline derivatives, or mixtures thereof.

79. The process for producing an epoxidized elastomeric polymer according to claim 77, wherein the epoxy group stabilizing agent is added in an amount of 0 phr to 10 phr.

80. The process for producing an epoxidized elastomeric polymer according to claim 79, wherein the epoxy group stabilizing agent is added in an amount of 0.1 phr to 5 phr.

81. The process according to claim 42, wherein the water is added in an amount of 0.1 phr to 50 phr.

82. The process according to claim 81, wherein the water is added in an amount of 0.5 phr to 20 phr.
